(19) United States
(12) Patent Application Publication
(10) Pub. No.: US 2010/0288390 A1
(43) Pub. Date: Nov. 18, 2010

(54) Flexible hose for conveying fluid materials and electric current

(75) Inventor: Giuseppe Aldinio Colbachini, Cervarese Santa Croce(PD) (IT)

Correspondence Address: HEDMAN & COSTIGAN, P.C., 1230 AVENUE OF THE AMERICAS, 7th floor, NEW YORK, NY, 10020, US

(73) Assignee: IVG COLBACHINI S.p.A., Cervarese Santa Croce (PD) (IT)

(21) Appl. No.: 12/798,138

(22) Filed: Mar. 30, 2010

(30) Foreign Application Priority Data
May 15, 2009 (IT) MI2009A000847

(51) Int. Cl. F16L 11/00; F16L 11/04

(52) U.S. Cl. 138/126; 138/137; 428/36.91

(57) ABSTRACT

A flexible hose, of the type consisting of a plurality of overlapping material layers, characterized in that said flexible hose comprises at least a layer of a plastics material having a small surface electric resistance.

### BACKGROUND OF THE INVENTION

The present invention relates to an improved flexible hose, designed for conveying fluid materials and electric current.

The field of the invention is that of flexible hoses used both for conveying fluid materials in general such as gas, liquid, powder materials, and for conveying electric current.

As is known, flexible hoses are moreover also used for exchanging data, between connection points of said flexible hose.

To that end, is also known to provide tubes or hoses including, in their structure, electric cables. Example of these prior approaches may be found in documents U.S. Pat. No. 5,416,270 and U.S. Pat. No. 4,693,324.

The above mentioned prior art, however, has the drawback of introducing in the tube an outer element which cannot be considered as congruent with the tube or hose layered construction, which element, more specifically, consists of the cable structures embedded in the hose wall forming material.

Accordingly, this prior hose or tube has a volume much larger than that required for transporting the fluid materials and, moreover, a smaller flexibility and a larger weight than those required for the above mentioned fluid material and current conveying applications.

### SUMMARY OF THE INVENTION

Accordingly, the aim of the present invention is to provide a flexible hose for conveying both fluid materials and an electric current which, with respect to like prior flexible hoses, has a much more simple construction, very similar to that of a flexible hose or tube for conveying only fluid materials.

The above aim, as well as other objects, which will become more apparent hereinafter, are achieved by a flexible hose according to claim 1.

Preferred embodiments of the inventive flexible hoses are defined in the dependent claims.

With respect to prior flexible hoses also allowing to convey electric signals, the inventive flexible hose provides the advantages that it does not include cables for said electric signals, thereby preserving optimum characteristics and qualities as conventionally required in flexible hoses for conveying fluid materials.

Moreover, the flexible hose according to the present invention allows to dissipate electrostatic charges accumulating on the hose walls as some materials are conveyed therethrough.

### BRIEF DESCRIPTION OF THE DRAWINGS

The above mentioned aim, as well as yet other objects, advantages and characteristics of the present invention will become more apparent hereinafter from the following detailed disclosure of a preferred embodiment of the inventive flexible hose which is illustrated, by way of an indicative, but not limitative, example in the accompanying drawings, where:

FIG. 1 is a broken away view of an embodiment of the flexible hose according to the present invention;

FIG. 2 shows a first modified embodiment of the flexible hose shown in FIG. 1, being provided with an inner reinforcement coil arrangement;

FIG. 3 shows a second modified embodiment of the flexible hose shown in FIG. 1, with an inner reinforcement coil arrangement and a corrugated outer layer;

FIG. 4 shows a third modified embodiment of the flexible hose of FIG. 1, further including a low surface electric resistance outer sheath; and

FIG. 5 shows yet another modified embodiment of the flexible hose of FIG. 1, in which a low surface electric resistance layer is embedded in the wall of the hose.

### DESCRIPTION OF THE PREFERRED EMBODIMENTS

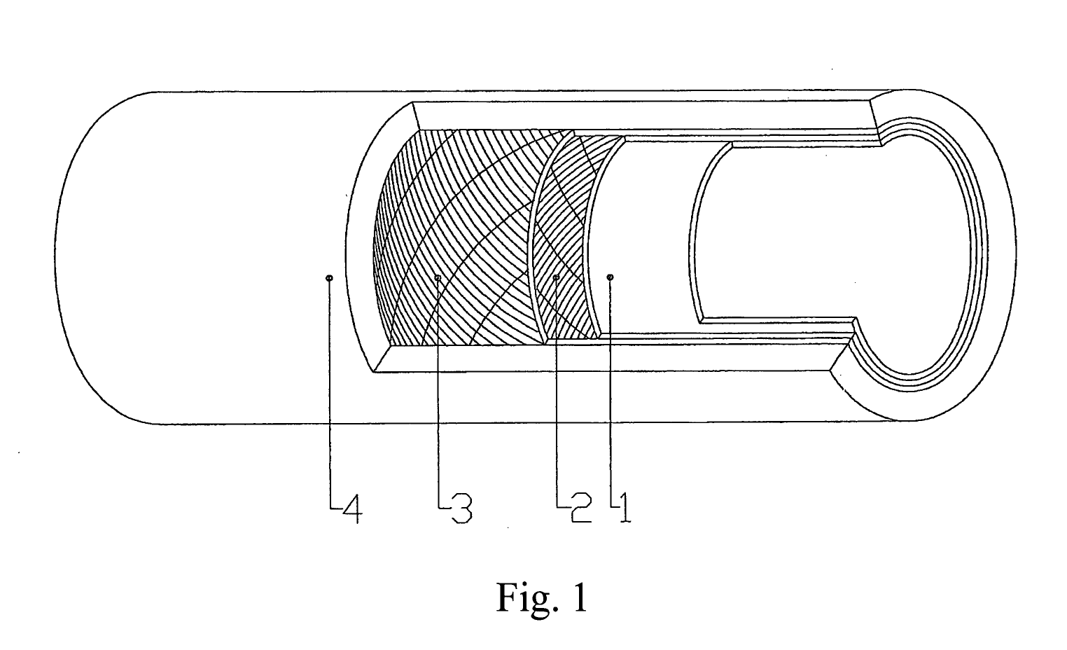

The flexible hose shown in FIG. 1 is of a type conventionally used for conveying fluid materials in general, both in a solid, liquid and gaseous status, in particular chemical or fuel products.

According to the present invention, the inventive flexible hose comprise a smooth flexible and clear plastics material layer 1, which has a low surface electric resistance.

More specifically, the plastics material forming said inner layer 1 comprises a flexible and clear plastics material, on which a thin film constituted by carbon nanotubes CNT is coated.

To provide a desired electric conductivity value, the thin film layer is firmly anchored to the polymeric material forming said layer 1, said nanotubes being only partially embedded in the thickness of the said layer 1.

Thus, the CNT formed film will preserve its surface electric conductivity properties, while being firmly anchored to its respective polymeric support 1.

Moreover, since said CNT film has good electric conductivity, clearness and flexibility properties, those same properties will be transferred to and preserved on the mentioned layer 1 of the inventive hose, which is per se made by a flexible and clear plastics material.

More specifically, the starting plastics material used for making the layer 1 of the inventive hose comprise a flexible and clear plastics material, in particular a thermoplastic polymer selected, preferably though not exclusively, from polyethylene, polypropylene, polybutadiene, polyamide 6,6, polyvinylchloride, polyacrylonitrylbutadienestyrene (ABS), or fluorinated polymers, such as polytetrafluoroethylene (Teflon), a terpolymer of tetrafluoroethylene, hexafluoropropylene and vinylidene fluoride (THV), a copolymer of tetrafluoroethylene and perfluoroalkylvinylether (PFA) or a tetrafluoroethylene perfluoroethylvinyl-ester (MFA) copolymer and a 1-propene, 1,1,2,3,3,3-hexafluoropolymer with tetrafluoroethene (polyfluoroethylene-propylene, FEP).

The single and multiple wall carbon nanotubes used by the invention have been synthetized at the start of 1990.

They comprise a novel form of nanostructured material (the single wall nanotubes having for example a diameter of the order of a nanometer and a length of the order of micrometers) based on carbon, having mechanical, strength and flexibility, and electric conductive properties which could be never found in any prior materials.

The CNT's suitable for the invention are both single wall carbon nanotubes SWNT, carbon double wall nanotubes DWNT, and carbon multiwall nanotubes MWNT.

In general, the plastics material used for forming the flexible hose of the invention has a surface electric resistance or resistivity less than 10¹³ kΩ/sq. In an example of a FEP layer thereon are coated a CNT film according to the present invention, it has a surface electric resistance or resistivity not larger than 10² kΩ/sq, in particular a surface electric resistance from 1 to 100 kΩ/sq.

On the above inner layer 1 of the flexible hose shown in FIG. 1, are moreover wound two reinforcement material layers 2 and 3, for example of a fabric material. Finally, an elastomeric material layer 4 is applied on the reinforcement layer 3.

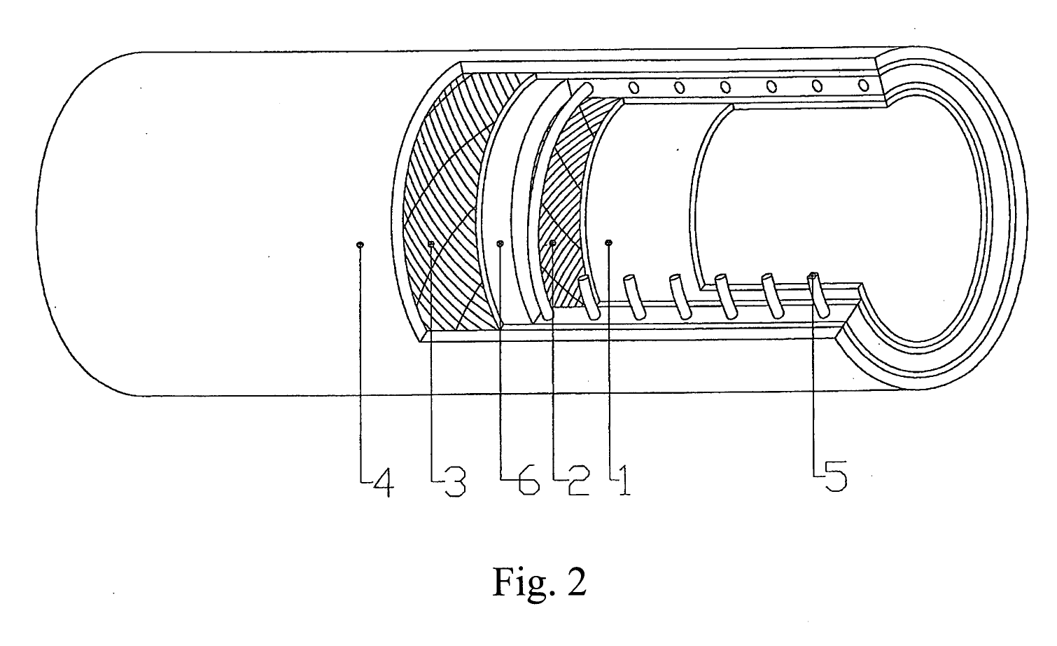

In the modified embodiment shown in FIG. 2, the flexible hose construction of FIG. 1 further comprises a reinforcement inner coil 5 made of a metal or synthetic or plastics material, in turn embedded in a thickness 6 of an elastomeric material.

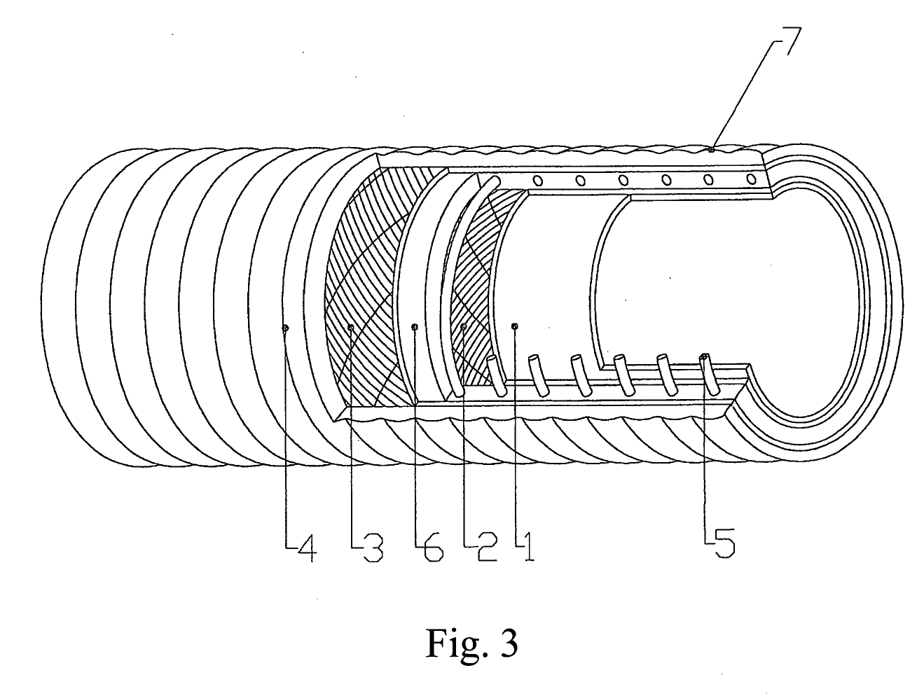

In the modified embodiment shown in FIG. 3, the flexible hose construction of FIG. 2 comprises a built-in outer layer 4 having a corrugated arrangement 7.

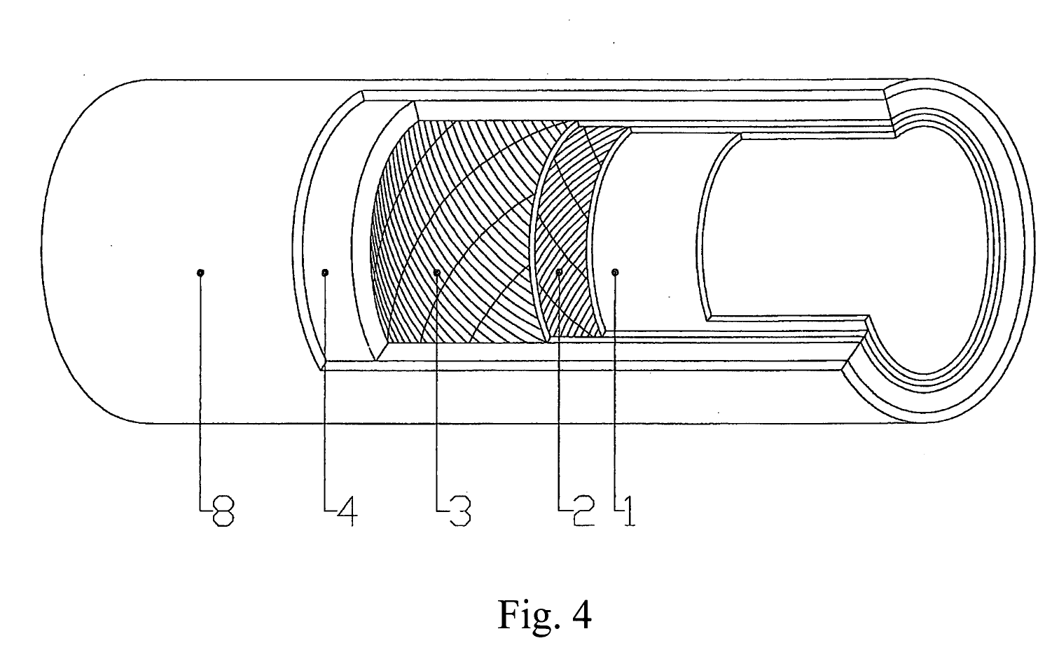

In the embodiment shown in FIG. 4, the flexible hose construction of FIG. 1 comprises a built-in low surface electric resistance outer layer 8, made of the same material as that forming the inner layer 1 and arranged on the top of the elastomeric material 4.

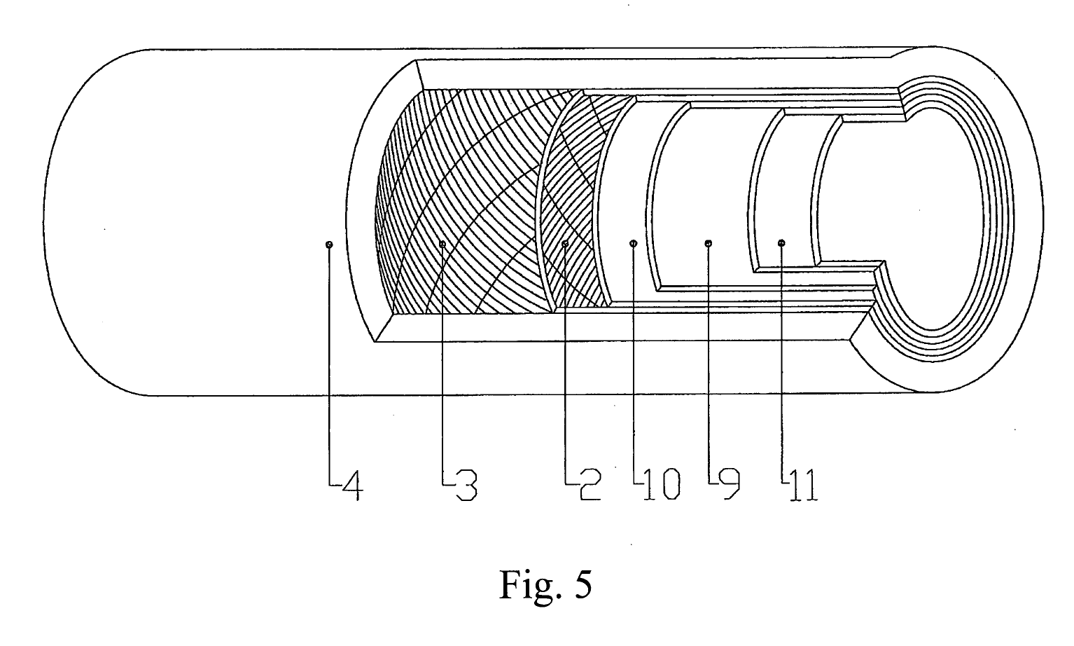

In the modified embodiment shown in FIG. 5, the inventive flexible hose comprises a low surface electric resistance or resistivity layer 9, analogous to the layer 1 of the hose of FIG. 1, but arranged between two elastomeric material layers 10 and 11.

Thus, said low surface electric resistance layer 9 is arranged inside the hose wall construction.

The invention, as disclosed and illustrated, is susceptible to several modifications for providing yet other modified embodiments not included among the above disclosed embodiments, but coming anyhow within the scope of the accompanying claims.

Thus, for example, the flexible hoses shown in FIGS. 1 and 3 could also comprise both the outer layer 8 of the hose of FIG. 4 and the layer 9 of the hose of FIG. 5.

Advantageously, said low surface electric resistance material inner 1 and outer 8 layers are also suitable for dissipating electrostatic charges accumulating on the hose as some fluid materials are conveyed therethrough.

In turn, the low surface electric resistance layer 9, embedded in the hose wall, is also very efficient for conveying electric signals.

1. A flexible hose, of the type consisting of a plurality of overlapping material layers, characterized in that said flexible hose comprises at least a layer of a plastics material having a small surface electric resistance.

2. A flexible hose, according to claim 1, characterized in that on said plastics material is anchored a carbon film including a plurality of nanotubes having a low surface electric resistance.

3. A flexible hose, according to claim 2, characterized in that said plastics material is a flexible and clear plastics material.

4. A flexible hose, according to claim 3, characterized in that said plastics material has a surface electric resistance less than 10¹³ kΩ/sq.

5. A flexible hose, according to claim 4, characterized in that said plastics material has a surface electric resistance less than 10² kΩ/sq.

6. A flexible hose, according to claim 5, characterized in that said plastics material comprises a thermoplastic polymer selected from polyethylene, polypropylene, polybutadiene, polyamide 6.6, polyvinylchloride, polyacrylonitrylebutadienestyrene (ABS) or a fluorine polymer.

7. A flexible hose, according to claim 6, characterized in that said fluorine polymer comprises polytetrafluoroethylene (Teflon), a terpolymer of tetrafluoroethylene, hexafluoropropylene and vinylidene fluoride (THV), a copolymer of tetrafluoroethylene and perfluoroalkylvinylether (PFA) or a copolymer of tetrafluoroethylene perfluoroethylvinyl-ester (MFA).

8. A flexible hose, according to claim 7, characterized in that said fluoridized polymer comprises 1-propene, a 1,1,2,3,3,3-hexafluoropolymer with tetrafluoroethene (polyfluoroethylene-propylene, FEP).

9. A flexible hose, according to claim 5, characterized in that said carbon nanotubes are single wall nanotubes (SWNT), double wall nanotubes (DWNT) or multi wall nanotubes (MWNT).

10. A flexible hose, according to claim 1, characterized in that said low surface electric resistance plastics material layer constitutes the innermost layer of said tube.

11. A flexible hose, according to claim 1, characterized in that said low surface electric resistance plastics material layer constitutes the outer layer of said tube.

12. A flexible hose, according to claim 1, characterized in that said low electric resistance plastics material layer is arranged inside the structure forming the wall of said tube.

13. A flexible hose, according to claim 12, characterized in that said layer is arranged between elastomeric material layers.

14. A flexible hose, according to claim 10, characterized in that said hose comprises moreover a reinforcement inner coil embedded in an elastomeric material layer.

15. A flexible hose, according to claim 10, characterized in that said flexible hose is a corrugated flexible hose.
